(19) United States
(12) Patent Application Publication
(10) Pub. No.: US 2003/0223375 A1
(43) Pub. Date: Dec. 4, 2003

(54) Apparatus and method for shared line testing

(76) Inventor: Dael Govreen-Segal, Hod Hasharon (IL)

Correspondence Address: Howard & Howard, Suite 101, 1400 North Woodward Avenue, Bloomfield Hills, MI, 48304-2856, US

(21) Appl. No.: 10/169,621

(22) PCT Filed: Jan. 1, 2001
(86) PCT No.: PCT/IL01/00003

(51) Int. Cl. H04L 1/00

(52) U.S. Cl. 370/248; 370/386

(57) ABSTRACT

Testing arrangement for use in a communications network carrying POTS and data traffic in an environment wherein a splitter (10) is located between a data subassembly and a voice subassembly on one side and a subscriber (14) on the other side.

### FIELD OF THE INVENTION

The present invention relates to testing apparatus and methodologies for telephone networks.

### BACKGROUND OF THE INVENTION

Various types of testing apparatus and methodologies for telephone networks are known. The following U.S. patents illustrate examples thereof U.S. Pat. Nos. 5,933,776; 4,942,603 and 3,937,908.

### SUMMARY OF THE INVENTION

The present invention seeks to provide improved testing apparatus and methodologies for telephone networks.

There is thus provided in accordance with a preferred embodiment of the present invention a testing arrangement for use in a communications network carrying POTS and data traffic in an environment wherein a splitter is located between a data subassembly and a voice subassembly on one side and a subscriber on an opposite side. The testing arrangement includes test equipment switchably connected between the splitter and the subscriber.

There is also provided in accordance with a preferred embodiment of the present invention a testing method for use in a communications network carrying POTS and data traffic in an environment wherein a splitter is located between a data subassembly and a voice subassembly on one side and a subscriber on an opposite side. The testing method includes switchably connecting test equipment between the splitter and the subscriber.

Further in accordance with a preferred embodiment of the present invention the test equipment is located in relative propinquity to the splitter and to the data subassembly and the voice subassembly and relative remotely from the subscriber.

Still further in accordance with a preferred embodiment of the present invention the testing arrangement also includes at least one switch interconnecting the test equipment with the splitter and the subscriber. Preferably, at least part of the switch is integrated with the splitter in a single housing.

Additionally in accordance with a preferred embodiment of the present invention the switch includes at least one first switch, switchably interconnecting the test equipment with a subscriber line extending from the splitter to the subscriber and at least one second switch switchably interconnecting the test equipment with the splitter.

Moreover in accordance with a preferred embodiment of the present invention the at least one second switch includes a pair of second switches and the splitter includes first and second frequency band filters. Preferably, each of the pair of second switches switchably interconnects one of the first and second frequency band filters to the test equipment.

Further in accordance with a preferred embodiment of the present invention the switch includes a high-impedance switch assembly for low interference switching between the test equipment and the subscriber line, thereby minimizing interference with live communications thereon.

Still further in accordance with a preferred embodiment of the present invention the test equipment includes a plurality of frequency band filters which are switchably interconnected in series between at least one test head and at least one of the subscriber lines and the splitter, thereby providing switchable testing of at least one of the subscriber lines and the splitter at a plurality of frequency bands.

Preferably, the switch interconnects the test equipment with the splitter and the subscriber. Additionally or alternatively at least part of the switch is integrated with the splitter in a single housing.

Additionally in accordance with a preferred embodiment of the present invention the switch includes at least one first switch, switchably interconnecting the test equipment with a subscriber line extending from the splitter to the subscriber and at least one second switch switchably interconnecting the test equipment with the splitter.

Further in accordance with a preferred embodiment of the present invention the test equipment includes a plurality of frequency band filters which are switchably interconnected in series between at least one test head and at least one of the subscriber lines and the splitter, thereby providing switchable testing of at least one of the subscriber line and the splitter at a plurality of frequency bands.

Still further in accordance with a preferred embodiment of the present invention the test equipment is located in relative propinquity to the splitter and to the data subassembly and the voice subassembly and relatively remotely from the subscriber.

There is provided in accordance with yet another preferred embodiment of the present invention a switching assembly useful in a testing arrangement for use in a communications network carrying POTS and data traffic in an environment wherein a splitter is located between a data subassembly and a voice subassembly on one side and a subscriber on an opposite side. The testing arrangement includes test equipment switchably connected between the splitter and the subscriber. The switching assembly includes at least one switch interconnecting the test equipment with the splitter and the subscriber.

There is also provided in accordance with a further preferred embodiment of the present invention a switching methodology useful in a testing arrangement for use in a communications network carrying POTS and data traffic in an environment wherein a splitter is located between a data subassembly and a voice subassembly on one side and a subscriber on an opposite side. The methodology includes switchably connecting test equipment between the splitter and the subscriber, including employing at least one switch for interconnecting the test equipment with the splitter and the subscriber.

Further in accordance with a preferred embodiment of the present invention at least part of the switch is integrated with the splitter in a single housing.

Still further in accordance with a preferred embodiment of the present invention the switch includes at least one first switch, switchably interconnecting the test equipment with a subscriber line extending from the splitter to the subscriber and at least one second switch switchably interconnecting the test equipment with the splitter.

Additionally in accordance with a preferred embodiment of the present invention at least one second switch includes a pair of second switches and the splitter includes first and second frequency band filters. Preferably, each of the pair of second switches switchably interconnects one of the first and second frequency band filters to the test equipment.

Further in accordance with a preferred embodiment of the present invention the switch includes a high-impedance switch assembly for low interference switching between the test equipment and the subscriber line, thereby minimizing interference with live communications thereon.

Still further in accordance with a preferred embodiment of the present invention the test equipment is located in relative propinquity to the splitter and to the data subassembly and the voice subassembly and relatively remotely from the subscriber.

There is further provided in accordance with yet another preferred embodiment of the present invention a switching matrix assembly useful with a switching assembly forming part of a testing arrangement for use in a communications network carrying POTS and data traffic in an environment wherein a splitter is located between a data subassembly and a voice subassembly on one side and a subscriber on an opposite side. The testing arrangement includes test equipment switchably connected between the splitter and the subscriber. The switching assembly includes at least one switch interconnecting the test equipment with the splitter and the subscriber. The switching matrix assembly also includes a plurality of frequency band filters which are switchably interconnected in series between the test equipment and at least one of the subscriber line and the splitter, thereby providing switchable testing of at least one of the subscriber line and the splitter at a plurality of frequency bands.

There is provided in accordance with another preferred embodiment of the present invention a splitter useful in a communications network carrying POTS and data traffic in an environment wherein a splitter is located between a data subassembly and a voice subassembly on one side and a subscriber on an opposite side and includes a testing arrangement. The testing arrangement includes test equipment switchably connected between the splitter and the subscriber, the splitter including at least one switch integrated with the splitter in a single housing.

Further in accordance with a preferred embodiment of the present invention the switch includes first and second switches arranged in series with respective high and low pass filters.

Still further in accordance with a preferred embodiment of the present invention the switch includes a high-impedance switch assembly for low interference switching between the test equipment and the subscriber line, thereby minimizing interference with live communications thereon.

Preferably the switch includes a high-impedance switch assembly for low interference switching between the test equipment and the subscriber line, thereby minimizing interference with live communications thereon.

There is further provided in accordance with another preferred embodiment of the present invention a switching matrix methodology useful with a switching methodology employed in a testing arrangement for use in a communications network carrying POTS and data traffic in an environment wherein a splitter is located between a data subassembly and a voice subassembly on one side and a subscriber on an opposite side. The testing arrangement includes test equipment switchably connected between the splitter and the subscriber. The switching methodology includes employing at least one switch interconnecting the test equipment with the splitter and the subscriber. The switching matrix methodology includes switchably interconnecting a plurality of frequency band filters in series between the test equipment and at least one of the subscriber line and the splitter, thereby provide switchable testing of at least one of the subscriber line and the splitter at a plurality of frequency bands.

### BRIEF DESCRIPTION OF THE DRAWINGS

The present invention will be understood and appreciated more fully from the following detailed description, taken in conjunction with the drawings in which:

FIGS. 1A and 1B are each a simplified block diagram illustration of a testing arrangement operative in a communications network carrying POTS and data traffic and which is constructed and operative in accordance with a preferred embodiment of the present invention;

FIGS. 2A, 2B, 2C, 2D and 2E are each an illustration of the testing arrangement of FIG. 1A in a specific switched mode of operation for providing a specific testing functionality; and

FIGS. 3A, 3B, 3C, 3D, 3E, 3F, 3G, 3H, 3I, 3J, 3K, 3L, 3M, 3N and 3O are each an illustration of the testing arrangement of FIG. 1B in a specific switched mode of operation for providing a specific testing functionality.

### DETAILED DESCRIPTION OF PREFERRED EMBODIMENTS

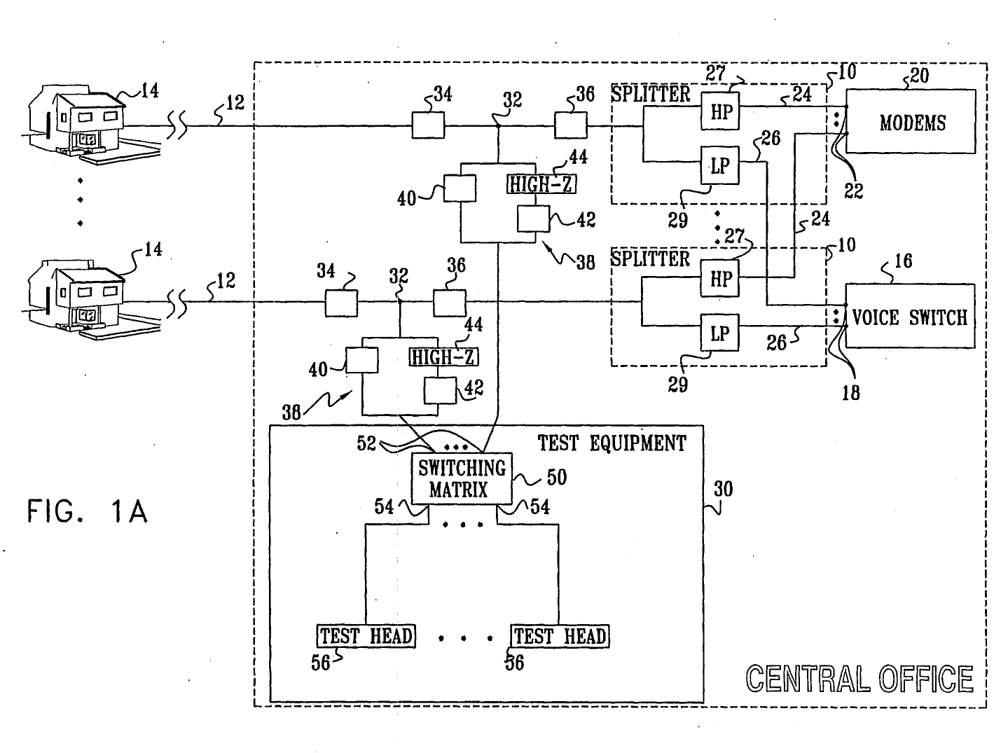

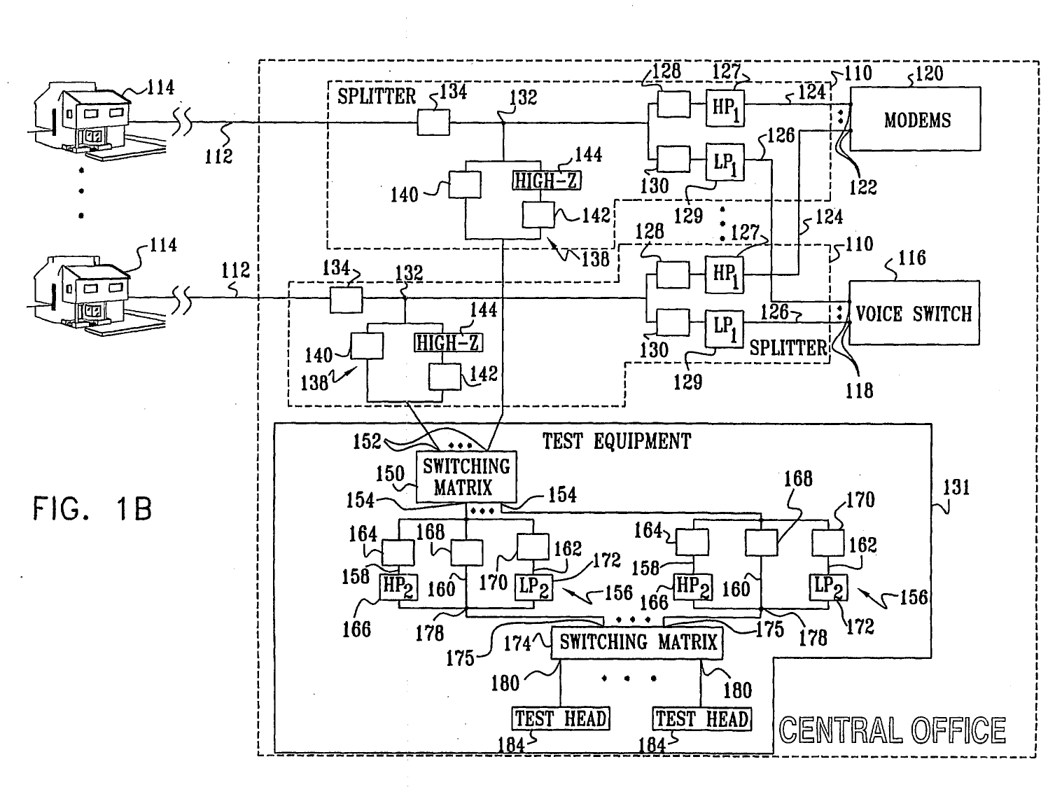

Reference is now made to FIG. 1A, which is a simplified block diagram illustration of a testing arrangement operative in a communications network carrying POTS and data traffic and which is constructed and operative in accordance with a preferred embodiment of the present invention. As seen in FIG. 1A, the testing arrangement resides in a Central Office environment comprising a plurality of splitters 10, one for each subscriber line 12, connected to each subscriber 14, one or more voice switches 16, each having a multiplicity of voice switch ports 18, one for each subscriber 14, and one or more modems 20, each typically having a multiplicity of modem ports 22, one for each subscriber 14.

In the illustrated embodiment, each splitter 10 is coupled along a subscriber line 12 to subscriber premises 14. The splitter 10 is additionally connected via a modem line 24 to a modem port 22 of a modem 20 and via a voice line 26 to a voice switch port 18 of a voice switch 16. A similar arrangement may be provided in a Remote Terminal environment wherein the splitters and modems are located in a Remote Terminal along with a voice multiplexer.

Each splitter 10 preferably comprises a high pass filter 27, which is connected in series along modem line 24, and a low pass filter 29, which is connected in series along voice line 26. Splitters 10 may be conventional splitters, such as ‘ADSL POTS Splitter Rack-Mount Shelf’ commercially available from Corning Cable Systems, Inc. Hickory, N.C., U.S.A.

In the illustrated embodiment of FIG. 1A and in accordance with a preferred embodiment of the present invention, test equipment 30 is switchably connected between the splitter 10 and the subscriber 14. As shown in FIG. 1A, the test equipment 30 is preferably connected to the subscriber line 12 at a connection junction 32 between switches 34 and 36.

The test equipment 30 is preferably connected to junction 32 via a parallel switch structure, generally indicated by reference numeral 38. Structure 38 preferably comprises a switch 40 arranged in parallel to a series combination of a switch 42 and a high impedance 44. The high impedance 44, which is typically in excess of 50 Kohms, may be provided by a single passive component or by any suitable impedance circuit.

In accordance with a preferred embodiment of the present invention, the test equipment 30 comprises a switching matrix 50 having a multiplicity of switching matrix subscriber ports 52, typically equal in number to the number of active subscribers 14. Each switching matrix port 52 is typically connected to a junction 32 of each subscriber line, via a switch structure 38.

The switching matrix 50 also has one or more switching matrix test ports 54, the number of which is typically substantially less than the number of switching matrix subscriber ports 52. The switching matrix 50 is operative to multiplex the test ports 54 onto the subscriber ports 52.

Connected to each switching matrix test port 54 there is preferably provided a test head 56. The test head 56 may be a conventional test head, such as a Digitest centralized network test platform, commercially available from Tollgrade Communications, Inc., Cheswick, Pa., U.S.A., or alternatively, a model TS-200 access network analyzer, commercially available from Tektronix, Inc. of Beaverton, Oreg., U.S.A.

Reference is now made to FIG. 1B, which is a simplified block diagram illustration of a testing arrangement operative in a communications network carrying POTS and data traffic and which is constructed and operative in accordance with a preferred embodiment of the present invention. Similarly to the embodiment of FIG. 1A, the testing arrangement resides in a Central Office environment comprising a plurality of splitters 110, one for each subscriber line 112, connected to each subscriber 114, one or more voice switches 116, each having a multiplicity of voice switch ports 118, one for each subscriber 114, and one or more modems 120, each typically having a multiplicity of modem ports 122, one for each subscriber 114.

In the illustrated embodiment, each splitter 110 is coupled along a subscriber line 112 to subscriber premises 114. The splitter 110 is additionally connected via a modem line 124 to a modem port 122 of a modem 120 and via a voice line 126 to a voice switch port 118 of a voice switch 116. A similar arrangement may be provided in a Remote Terminal environment wherein the splitters and modems are located in a Remote Terminal along with a voice multiplexer.

As distinct from the embodiment of FIG. 1A, in the embodiment of FIG. 1B, each splitter 110 preferably comprises a first high pass filter 127, which is connected in series with a switch 128 along modem line 124, and a first low pass filter 129, which is connected in series with a switch 130 along voice line 126.

In the illustrated embodiment of FIG. 1B and in accordance with a preferred embodiment of the present invention, test equipment 131 is switchably connected between the first high pass filter 127 and the first low pass filter 129 on one side and the subscriber 114 on an opposite side. As shown in FIG. 1B, the test equipment 131 is preferably connected to the subscriber line 112 at a connection junction 132 between the switch 134 and switches 128 and 130.

The test equipment 131 is preferably connected to junction 132 via a parallel switch structure, generally indicated by reference numeral 138. Structure 138 preferably comprises a switch 140 arranged in parallel to a series combination of a switch 142 and a high impedance 144. The high impedance 144, which is typically in excess of 50 Kohms, may be provided by a single passive component or by any suitable impedance circuit.

In accordance with a preferred embodiment of the present invention, the test equipment 131 comprises a first switching matrix 150 having a multiplicity of switching matrix subscriber ports 152, typically equal in number to the number of active subscribers 114. Each switching matrix port 152 is typically connected to a junction 132 of each subscriber line, via a switch structure 138.

The first switching matrix 150 also has one or more switching matrix test ports 154, the number of which is typically substantially less than the number of switching matrix subscriber ports 152. The first switching matrix 150 is operative to multiplex the test ports 154 onto the subscriber ports 152.

Connected to each switching matrix test port 154 there is preferably provided a parallel structure 156 of three testing paths 158, 160 and 162. Testing path 158 includes a switch 164 and a second high pass filter 166; testing path 160 includes a switch 168 and testing path 162 includes a switch 170 and a second low pass filter 172.

Each parallel structure 156 is connected to a second switching matrix 174, having a multiplicity of subscriber-side switching matrix ports 175, typically equal in number to the number of test ports 154 of the first switching matrix 150. Each subscriber-side switching matrix port 175 is typically connected to a junction 178 of each parallel structure 156.

Second switching matrix 174 is also provided with one or more test-side switching matrix ports 180, each of which is connected to a test head 184. The test head 184 may be a conventional test head, such as a Digitest centralized network test platform, commercially available from Tollgrade Communications, Inc., Cheswick, Pa., U.S.A., or alternatively, a model TS-200 access network analyzer, commercially available from Tektronix, Inc. of Beaverton, Oreg., U.S.A.

In an improved implementation, switching matrix 150 is actually broken into sub-segments, some of which are integrated into the splitter 110.

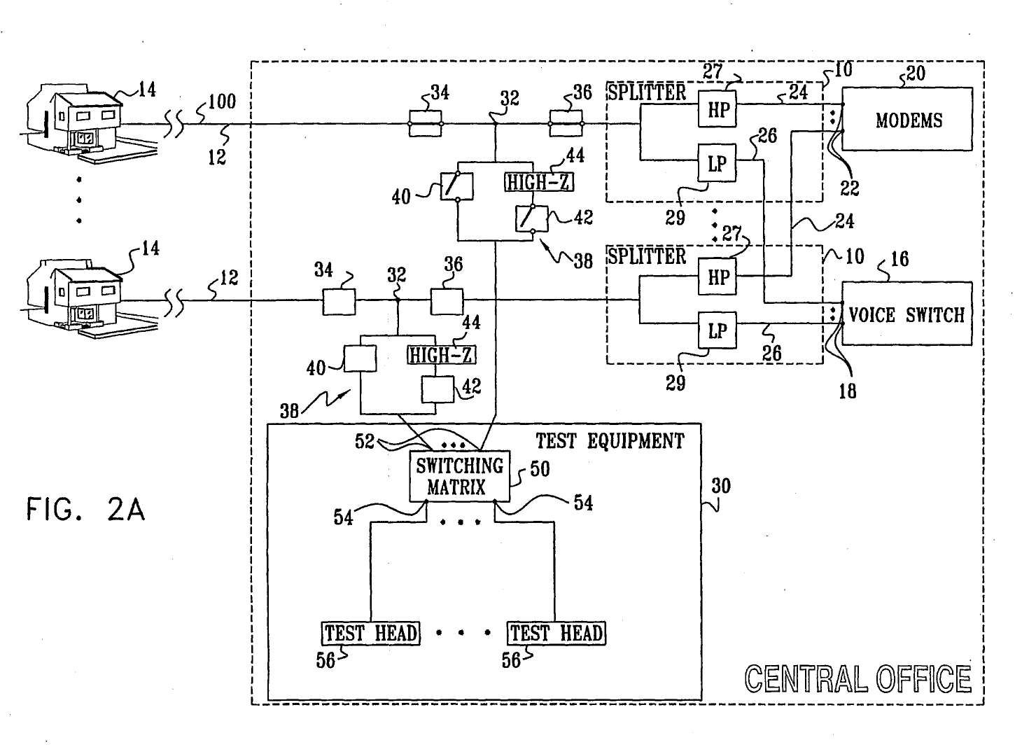

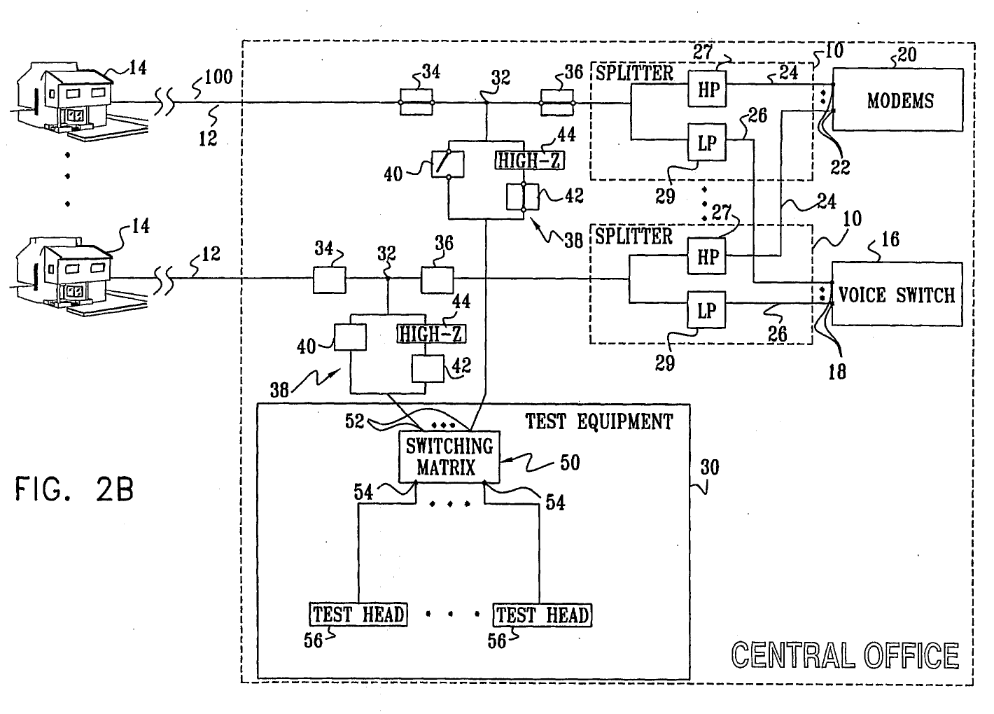

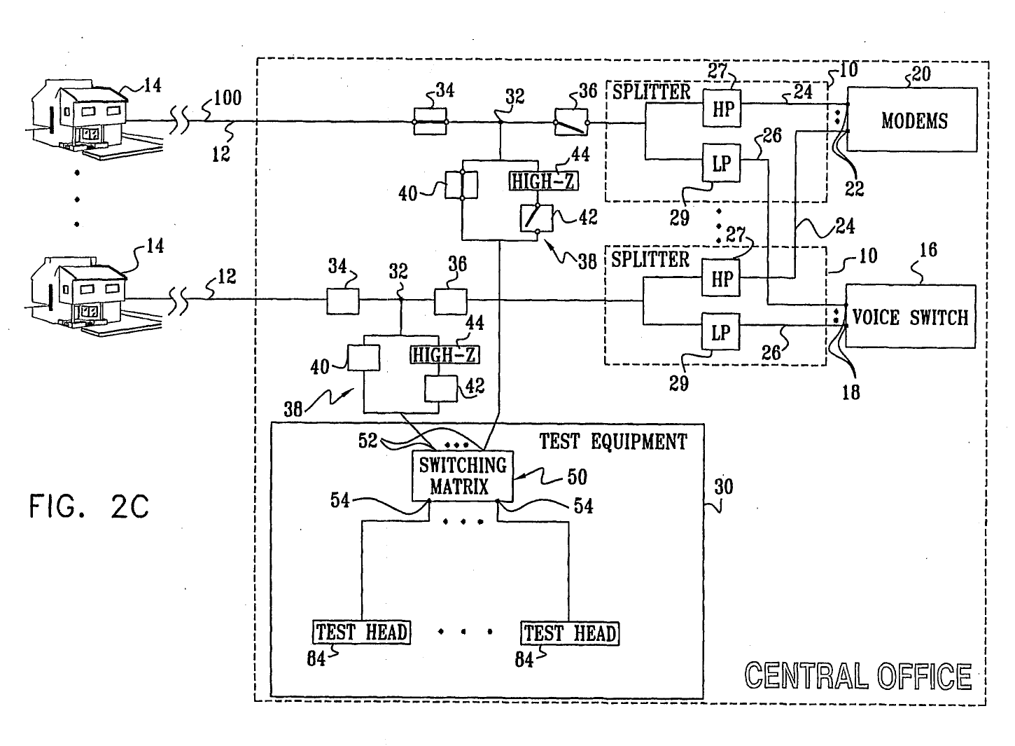

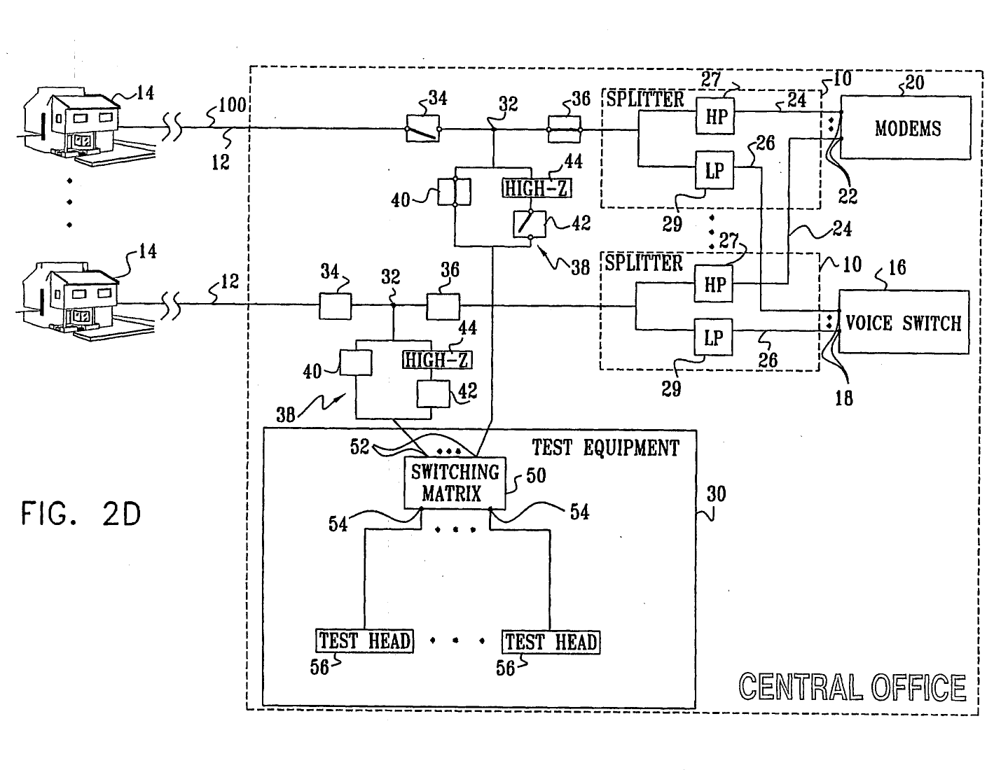

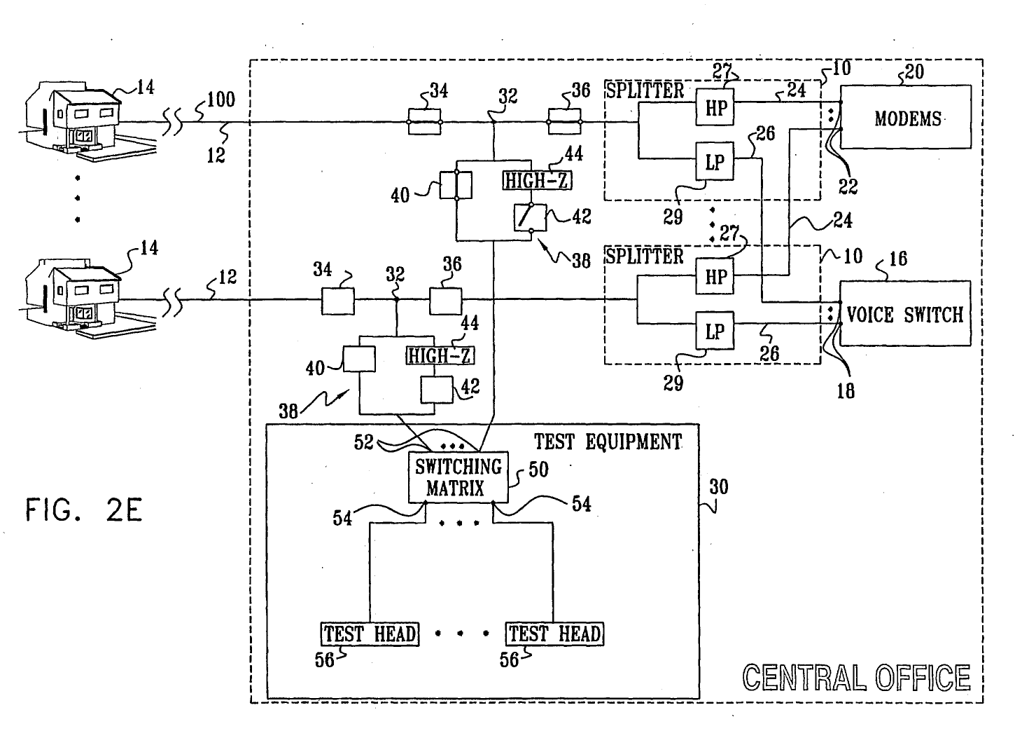

Reference is now made to FIGS. 2A, 2B, 2C, 2D and 2E, each being an illustration of the testing arrangement of FIG. 1A in a specific switched mode of operation for providing a specific testing functionality.

As seen in FIG. 2A, in a first mode of operation in testing a subscriber line designated by reference numeral 100, switches 34 and 36 are closed and switches 40 and 42 are open. In this mode of operation, the communications network operates normally and no testing takes place.

As seen in FIG. 2B, in a second mode of operation in testing a subscriber line designated by reference numeral 100, switches 34, 36 and 42 are closed and switch 40 is open. In this mode of operation, the test equipment 30 is connected through high impedance 44 to subscriber line 100, enabling monitoring of the subscriber line 100 without interruption to normal operation of the communications network.

As seen in FIG. 2C, in a third mode of operation in testing a subscriber line designated by reference numeral 100, switches 34 and 40 are closed and switches 36 and 42 are open. In this mode of operation, the test equipment 30 is connected directly to the subscriber line 100 and is disconnected from the splitter 10. This enables testing the integrity of the subscriber line 100 and subscriber equipment.

As seen in FIG. 2D, in a fourth mode of operation in testing a subscriber line designated by reference numeral 100, switches 36 and 40 are closed and switches 34 and 42 are open. In this mode of operation, the test equipment 30 is connected to the splitter 10 and disconnected from the subscriber 14. This enables testing the integrity of the subscriber side of the splitter 10 as well as emulation of subscriber equipment.

As seen in FIG. 2E, in a fifth mode of operation in testing a subscriber line designated by reference numeral 100, switches 34, 36 and 40 are closed and switch 42 is open. In this mode of operation, the test equipment 30 is connected to subscriber line 100, enabling testing of the subscriber line 100 during operation of the communications network.

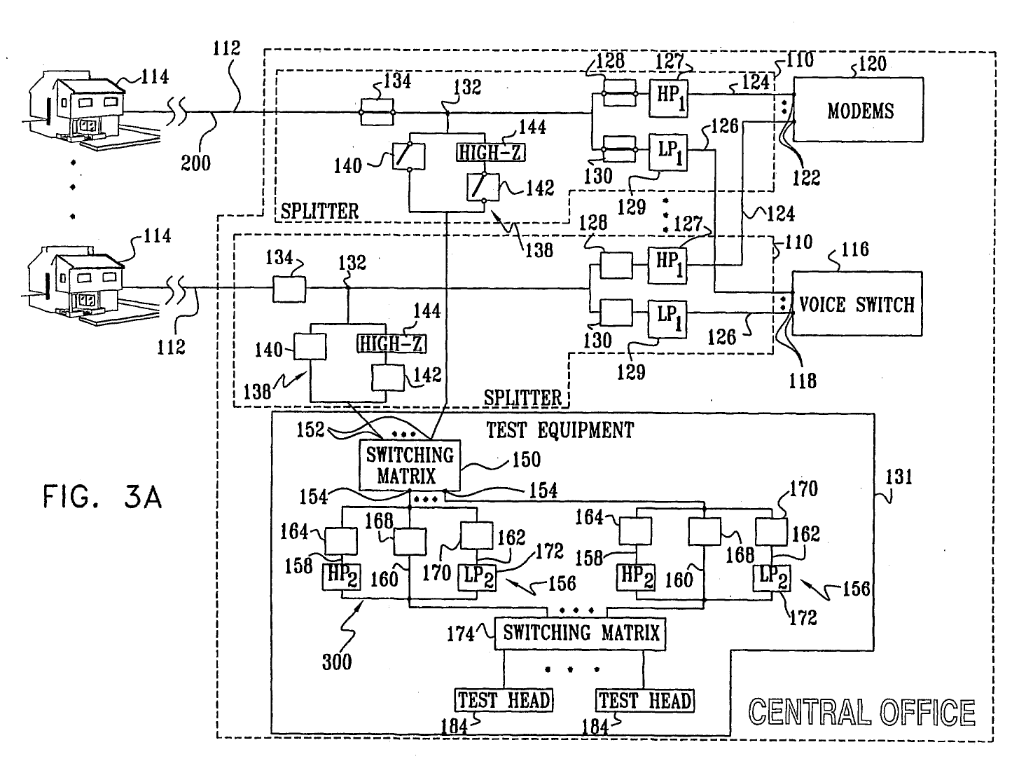

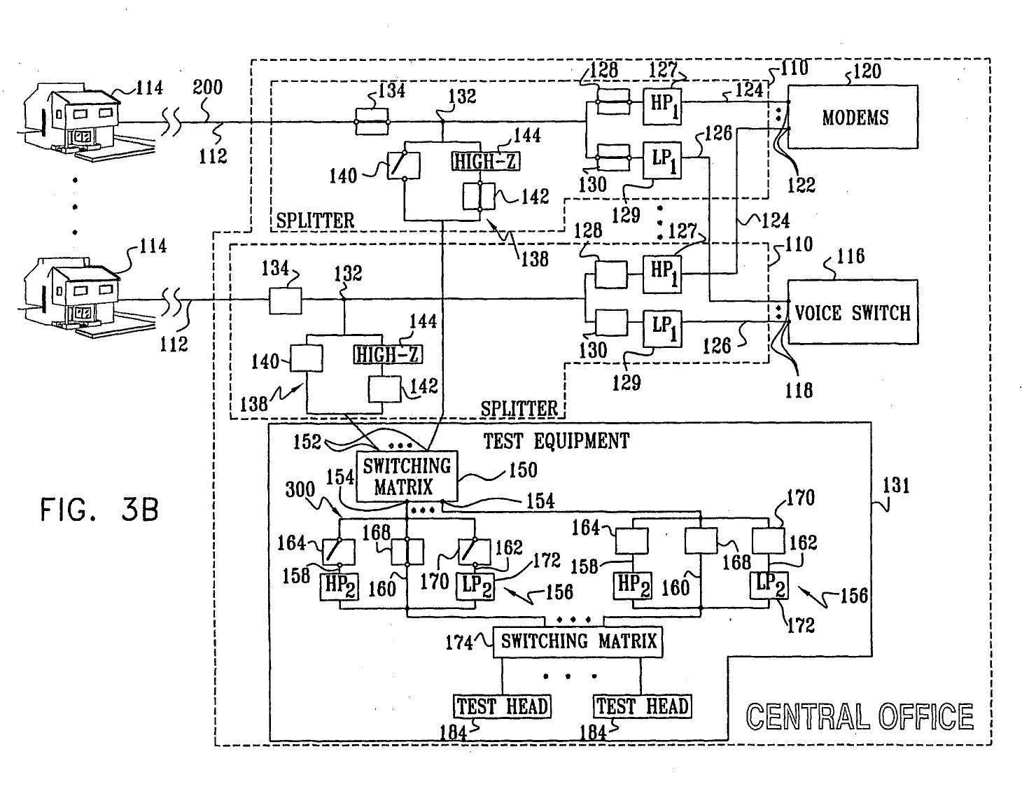

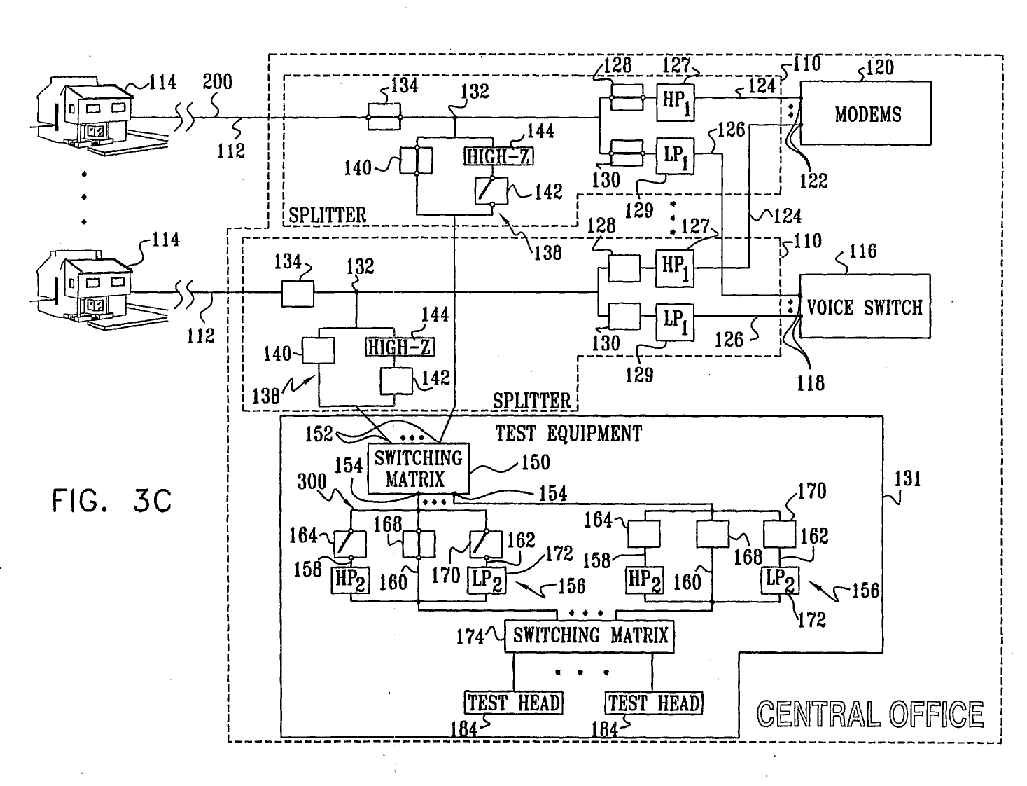

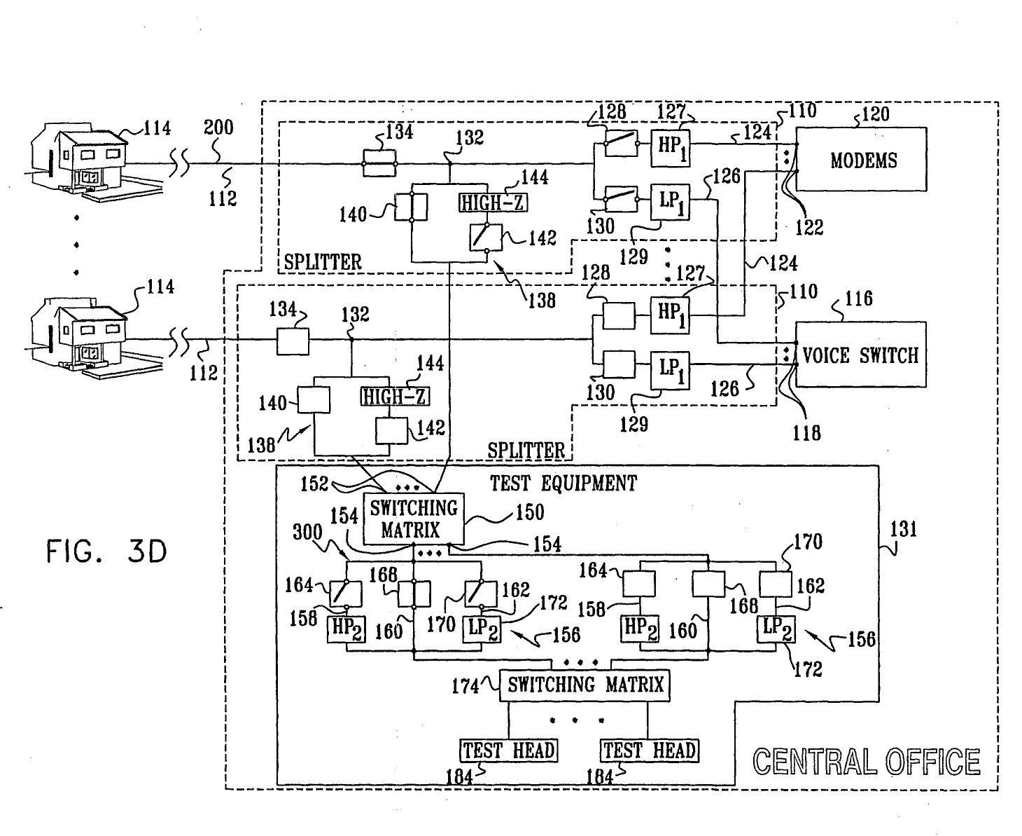

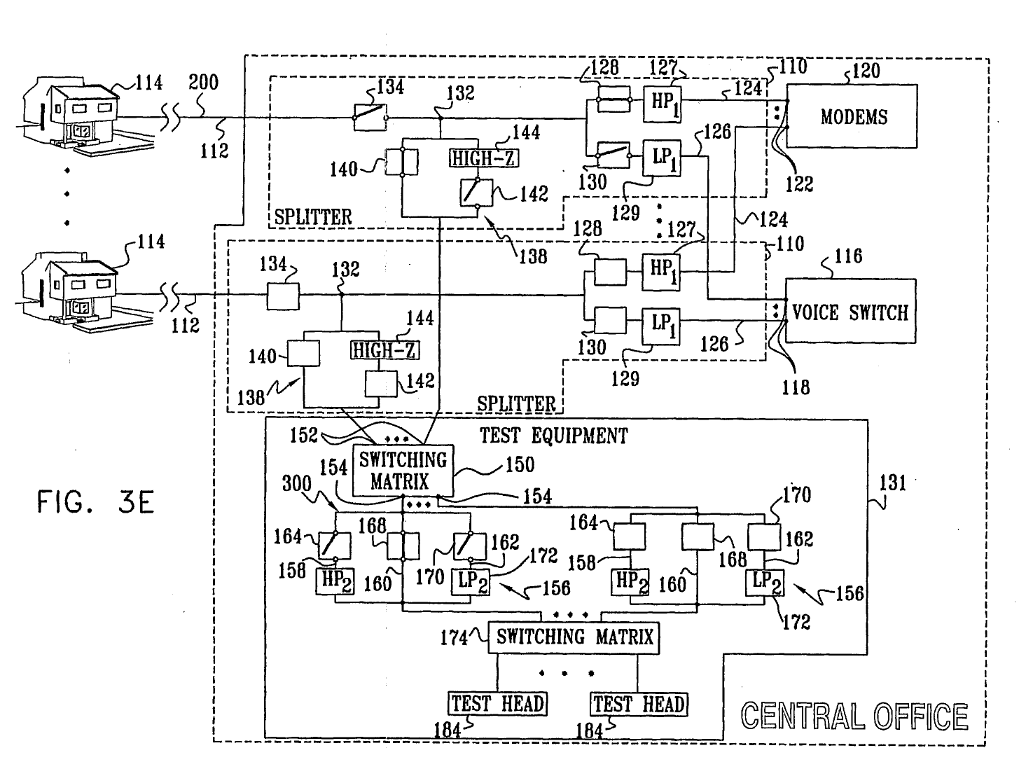

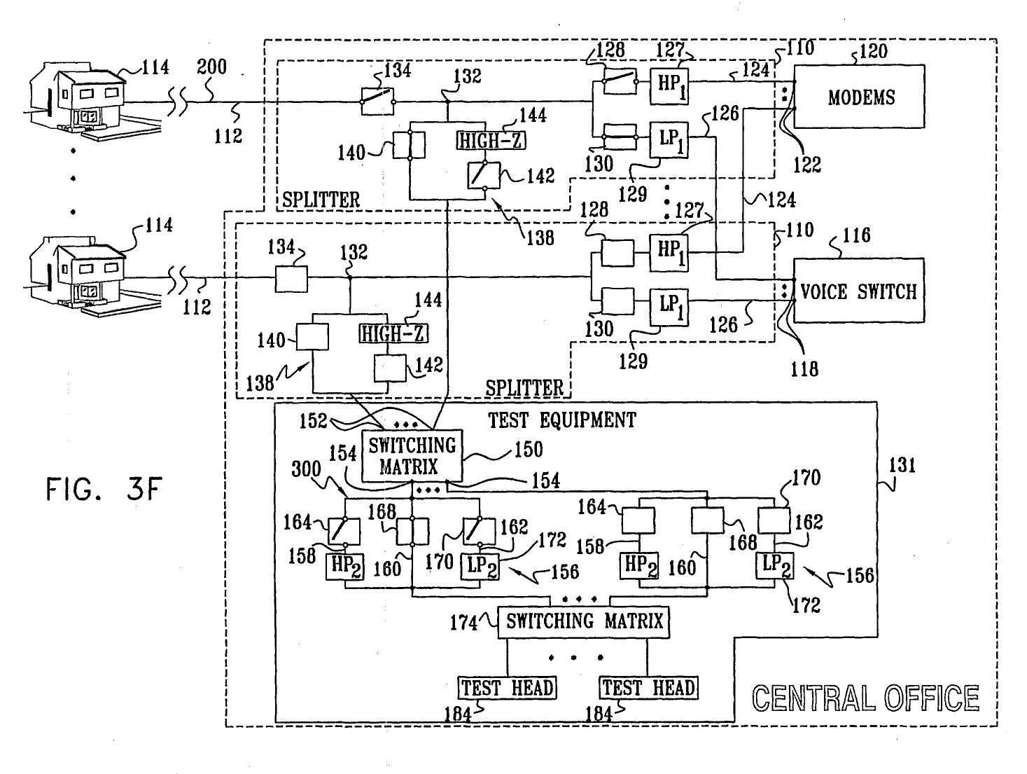

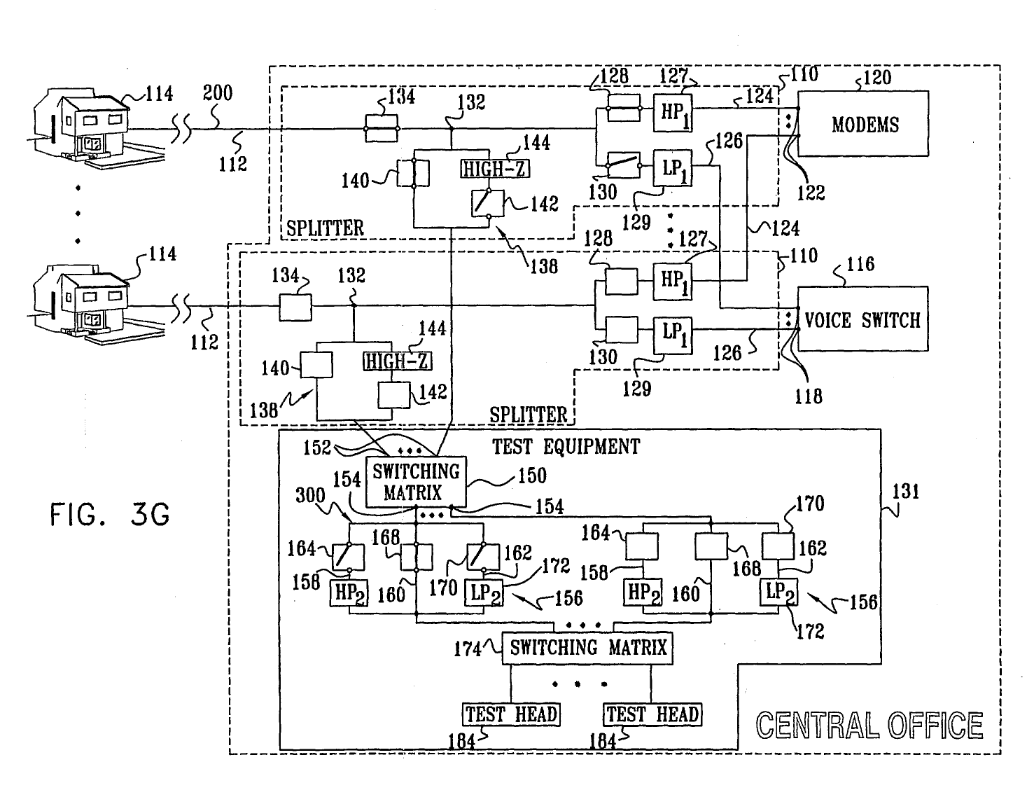

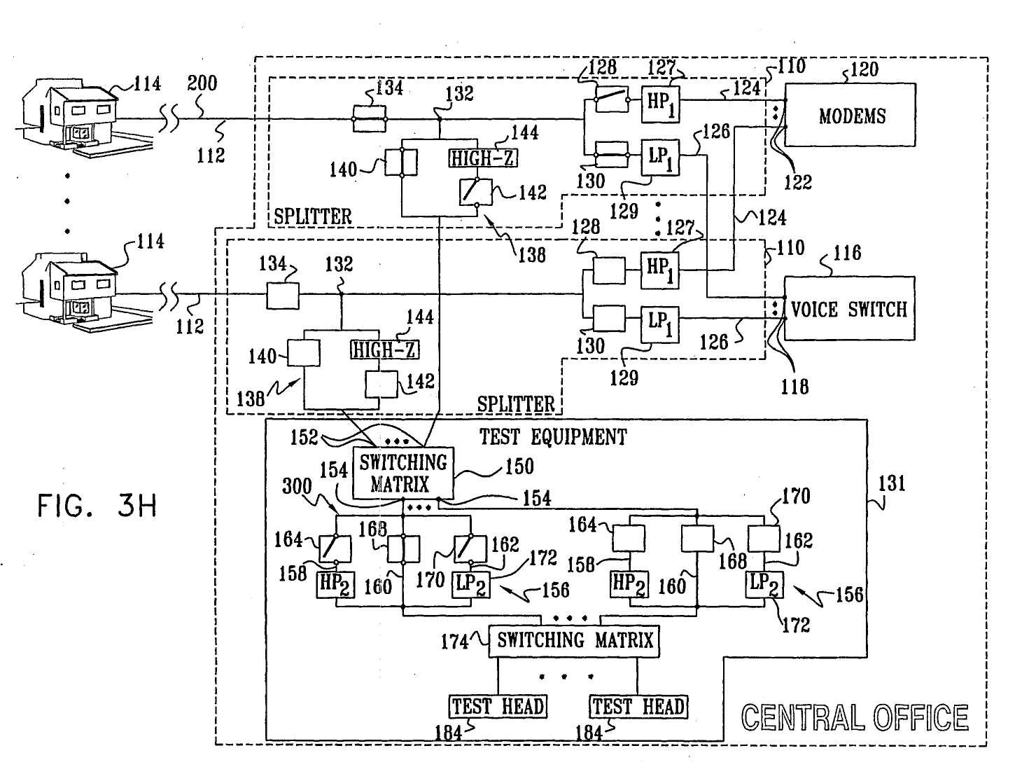

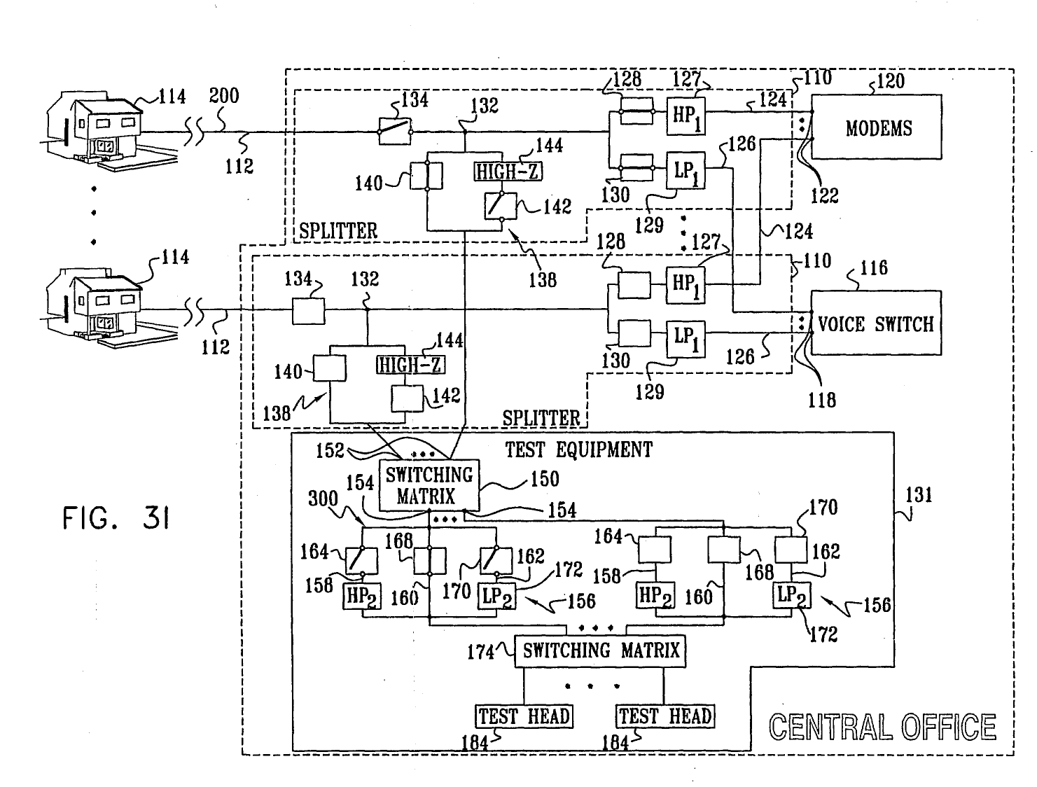

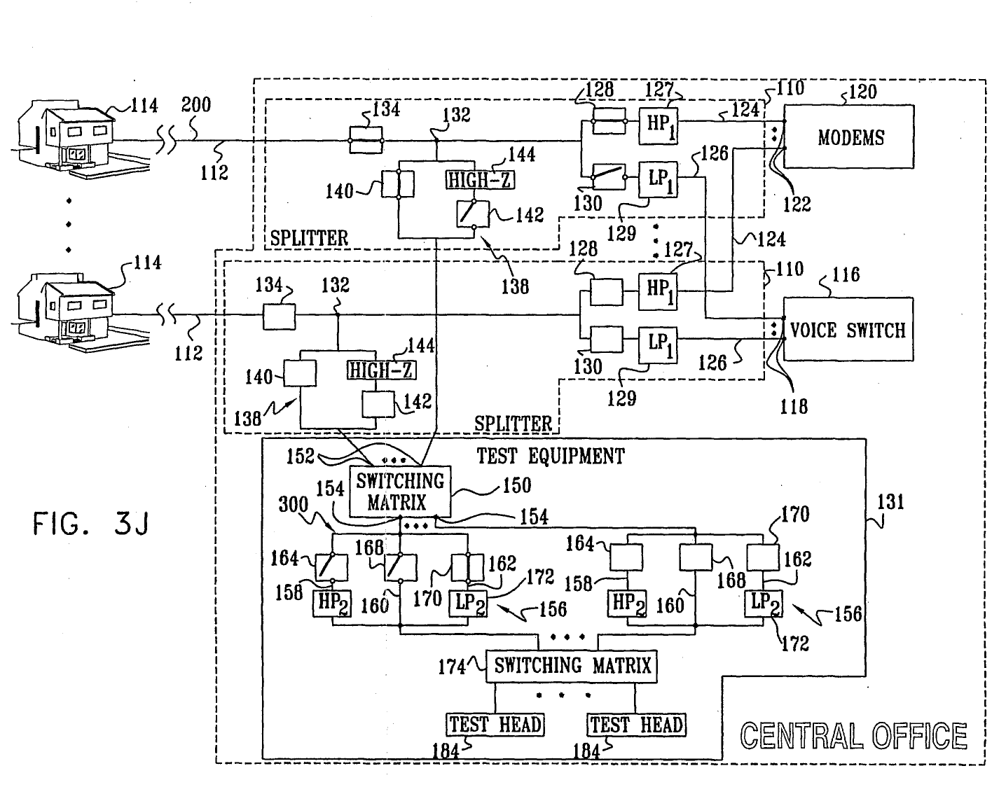

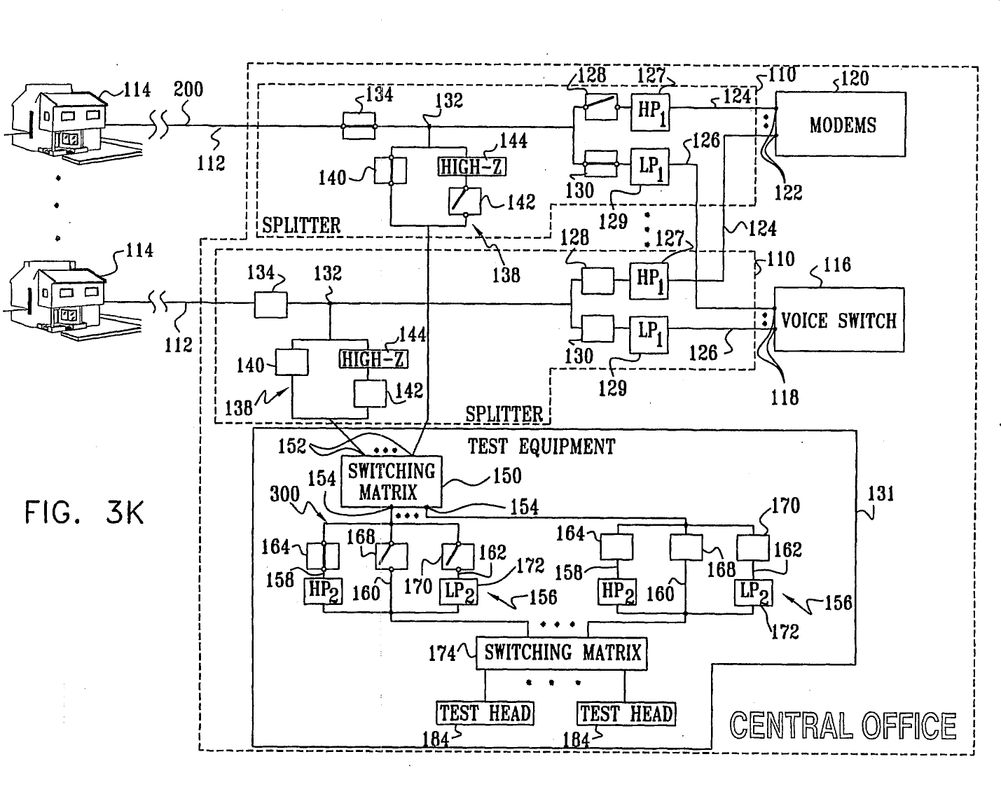

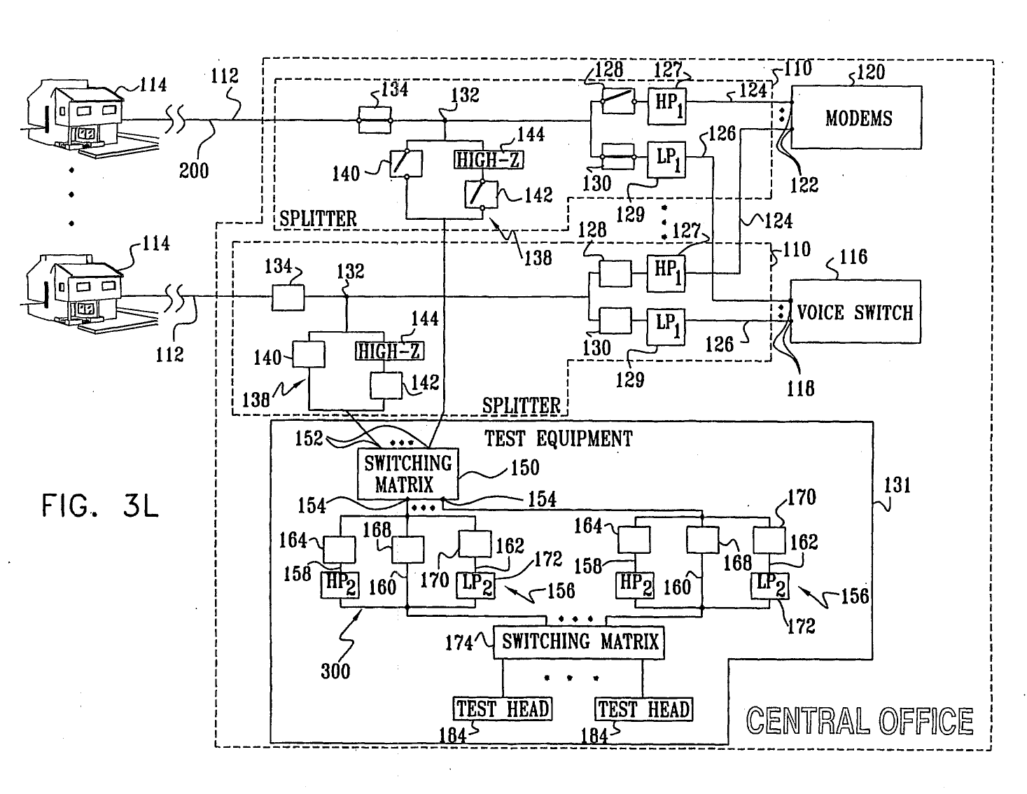

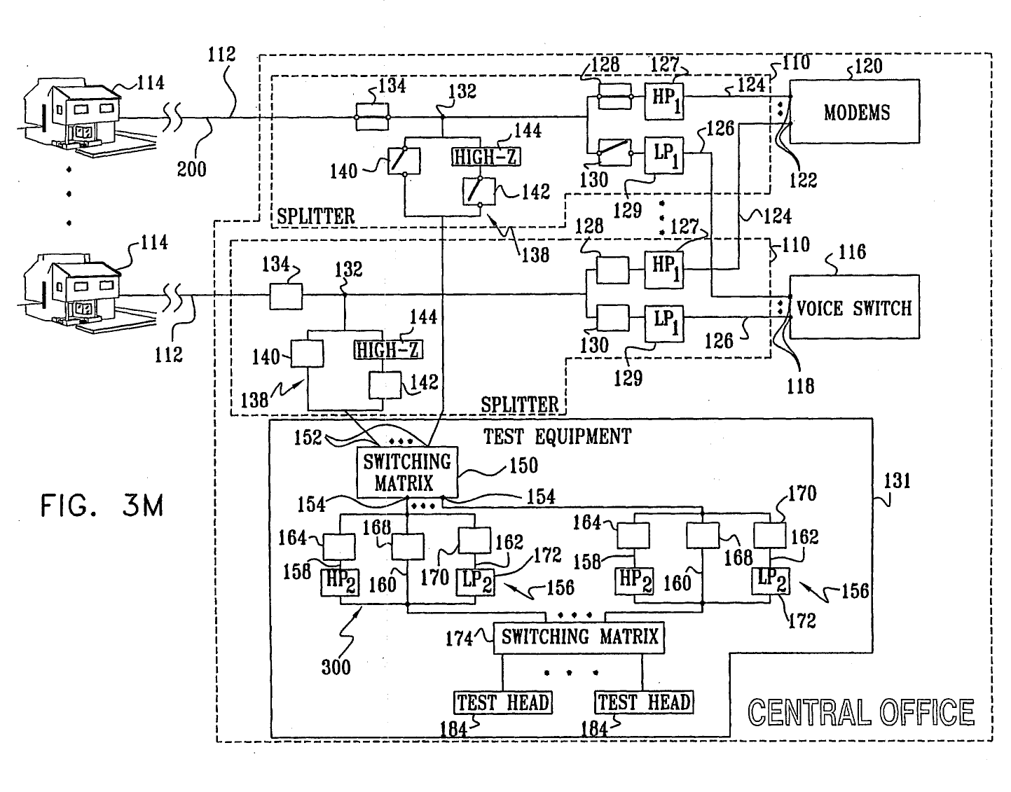

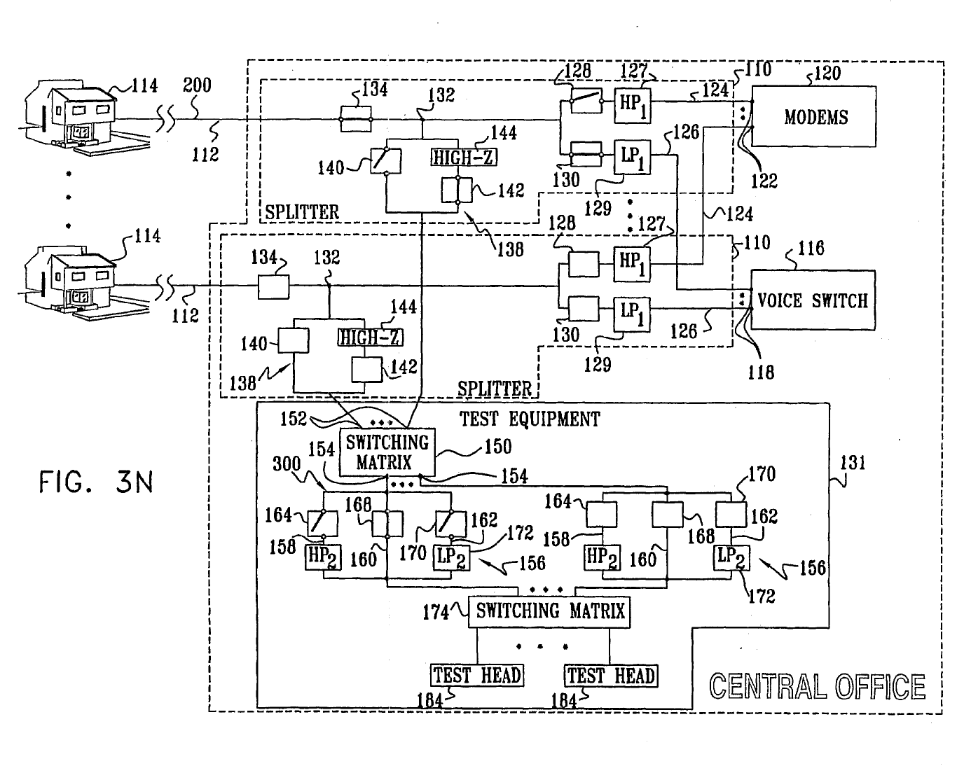

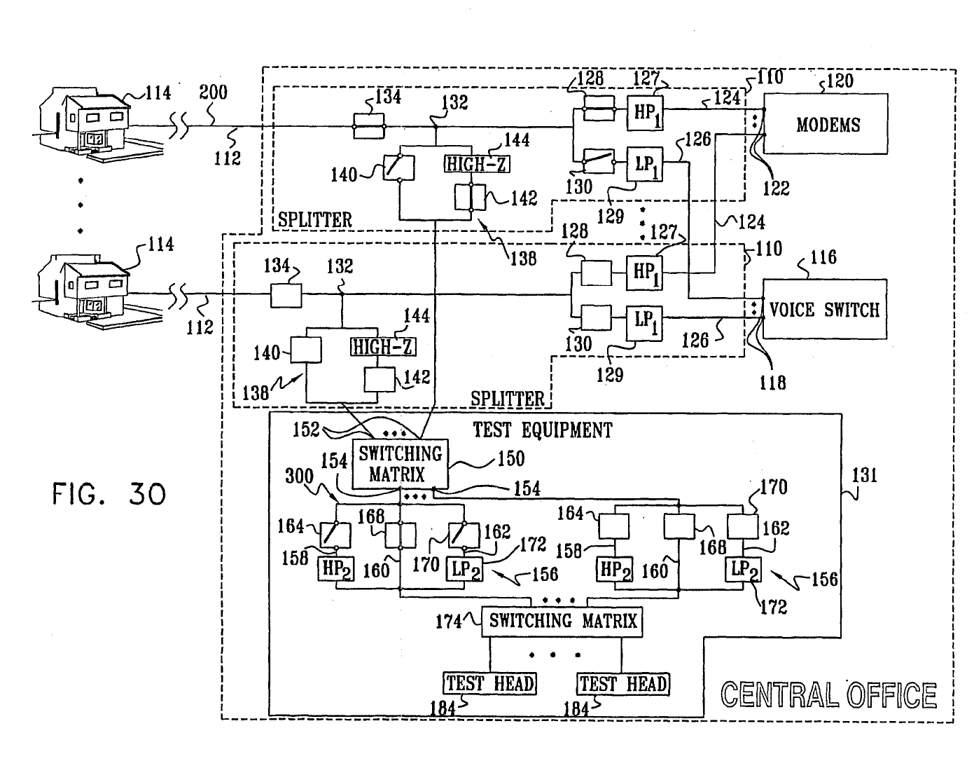

Reference is now made to FIGS. 3A, 3B, 3C, 3D, 3E, 3F, 3G, 3H, 3I, 3J, 3K, 3L, 3M, 3N and 3O, which are each an illustration of the testing arrangement of FIG. 1B in a specific switched mode of operation for providing a specific testing functionality.

As seen in FIG. 3A, in a first mode of operation in testing a subscriber line designated by reference numeral 200, switches 128, 130 and 134 are closed and switches 140 and 142 are open. In this mode of operation, the communications network operates normally and no testing takes place.

As seen in FIG. 3B, in a second mode of operation in monitoring a subscriber line designated by reference numeral 200 using a parallel structure 300, switches 128, 130, 134, 142 and 168 are closed and switches 140, 164 and 170 are open. In this mode of operation, the test equipment 131 is connected through high impedance 144 to subscriber line 200, enabling monitoring of the subscriber line 200 without interruption to normal operation of the communications network.

As seen in FIG. 3C, in a third mode of operation in testing a subscriber line designated by reference numeral 200 using a parallel structure 300, switches 128, 130, 134, 140 and 168 are closed and switches 142, 164 and 170 are open. In this mode of operation, the test equipment 131 is connected to subscriber line 200, enabling testing of the subscriber line 200 during operation of the communications network.

As seen in FIG. 3D, in a fourth mode of operation in testing a subscriber line designated by reference numeral 200 using a parallel structure 300, switches 134, 140 and 168 are closed and switches 128, 130, 142, 164 and 170 are open. In this mode of operation, the test equipment 131 is connected to subscriber line 200, enabling testing of the subscriber line 200 and subscriber equipment.

As seen in FIG. 3E, in a fifth mode of operation in testing a subscriber line designated by reference numeral 200 using a parallel structure 300, switches 128, 140 and 168 are closed and switches 130, 134, 142, 164 and 170 are open. In this mode of operation, the test equipment 131 is connected to modem line 124, enabling testing of the subscriber side of the first high pass filter 127 and operation of the modem 120.

As seen in FIG. 3F, in a sixth mode of operation in testing a subscriber line designated by reference numeral 200 using a parallel structure 300, switches 130, 140 and 168 are closed and switches 128, 134, 142, 164 and 170 are open. In this mode of operation, the test equipment 131 is connected to voice line 126, enabling testing of the subscriber side of the first low pass filter 129 and operation of the voice switch 116.

As seen in FIG. 3G, in a seventh mode of operation in testing a subscriber line designated by reference numeral 200 using a parallel structure 300, switches 128, 134, 140 and 168 are closed and switches 130, 142, 164 and 170 are open. In this mode of operation, the test equipment 131 is connected to subscriber line 200 and to the modem line 124, enabling testing of the subscriber line when the voice switch 116 is disconnected from the communications network.

As seen in FIG. 3H, in a eighth mode of operation in testing a subscriber line designated by reference numeral 200 using a parallel structure 300, switches 130, 134, 140 and 168 are closed and switches 128, 142, 164 and 170 are open. In this mode of operation, the test equipment 131 is connected to subscriber line 200 and to the voice line 126, enabling testing of the subscriber line when the modem 120 is disconnected from the communications network.

As seen in FIG. 3I, in a ninth mode of operation in testing a subscriber line designated by reference numeral 200 using a parallel structure 300, switches 128, 130, 140 and 168 are closed and switches 134, 142, 164 and 170 are open. In this mode of operation, the test equipment 131 is connected to voice line 126 and to the modem line 124, enabling testing of central office equipment and connections when the subscriber line 200 is disconnected from the communications network.

As seen in FIG. 3J, in a tenth mode of operation in testing a subscriber line designated by reference numeral 200 using a parallel structure 300, switches 128, 134, 140 and 170 are closed and switches 130, 142, 164 and 168 are open. In this mode of operation, the test equipment 131 is connected to the subscriber line 200 and to the modem line 124, enabling testing of the subscriber line when the voice switch 116 is disconnected from the communications network without disrupting data communication along the subscriber line 200.

As seen in FIG. 3K, in a eleventh mode of operation in testing a subscriber line designated by reference numeral 200 using a parallel structure 300, switches 130, 134, 140 and 164 are closed and switches 128, 142, 168 and 170 are open. In this mode of operation, the test equipment 131 is connected to the subscriber line 200 and to the voice line 126, enabling testing of the subscriber line when the modem 120 is disconnected from the communications network, without disrupting voice communication along the subscriber line 200.

As seen in FIG. 3L, in a twelfth mode of operation in testing a subscriber line designated by reference numeral 200, switches 130 and 134 are closed and switches 128, 140 and 142 are open. In this mode of operation, the modem 120 and the test equipment 131 are disconnected from the network, enabling isolation of faults in the modem line 124.

As seen in FIG. 3M, in a thirteenth mode of operation in testing a subscriber line designated by reference numeral 200, switches 128 and 134 are closed and switches 130, 140 and 142 are open. In this mode of operation, the voice switch 116 and the test equipment 131 are disconnected from the network, enabling isolation of faults in the voice line 126.

As seen in FIG. 3N, in a fourteenth mode of operation in monitoring a subscriber line designated by reference numeral 200 using a parallel structure 300, switches 130, 134, 142 and 168 are closed and switches 128, 140, 164 and 170 are open. In this mode of operation, the modem 120 is disconnected from the network and the test equipment 131 is connected through high impedance 144 to subscriber line 200, enabling monitoring of the subscriber line 200 without interruption to normal operation of the voice communications network.

As seen in FIG. 3O, in a fifteenth mode of operation in monitoring a subscriber line designated by reference numeral 200 using a parallel structure 300, switches 128, 134, 142 and 168 are closed and switches 130, 140, 164 and 170 are open. In this mode of operation, the voice switch 116 is disconnected from the network and the test equipment 131 is connected through high impedance 144 to subscriber line 200, enabling monitoring of the subscriber line 200 without interruption to normal operation of the data communications network.

It is appreciated that other modes of operation may also be provided by the apparatus and methodology of the present invention.

It will be appreciated by persons skilled in the art that the present invention is not limited by what has been particularly shown and described hereinabove. Rather the present invention includes both combinations and subcombinations of the various features described hereinabove as well as variations and developments thereof which would occur to a person skilled in the art upon reading the foregoing description and which are not in the prior art.

1. A testing arrangement for use in a communications network carrying POTS and data traffic in an environment wherein a splitter is located between a data subassembly and a voice subassembly on one side and a subscriber on an opposite side, the testing arrangement comprising test equipment switchably connected between said splitter and said subscriber.

2. A testing arrangement according to claim 1 and wherein said test equipment is located in relative propinquity to said splitter and to said data subassembly and said voice subassembly and relative remotely from said subscriber.

3. A testing arrangement according to claim 1 and also including at least one switch interconnecting said test equipment with at least one of said splitter and said subscriber.

4. A testing arrangement according to claim 3 and wherein at least part of said at least one switch is integrated with said splitter in a single housing.

5. A testing arrangement according to claim 3 and wherein said at least one switch includes at least one first switch, switchably interconnecting said test equipment with a subscriber line extending from said splitter to said subscriber and at least one second switch switchably interconnecting said test equipment with said splitter.

6. A testing arrangement according to claim 5 and wherein
said at least one second switch comprises a pair of second switches; and
said splitter comprises first and second frequency band filters; and wherein
each of said pair of second switches switchably interconnects one of said first and second frequency band filters to said test equipment.

7. A testing arrangement according to claim 3 and wherein said at least one switch includes a high-impedance switch assembly for low interference switching between said test equipment and said subscriber line, thereby to minimize interference with live communications thereon.

8. A testing arrangement according to claim 1 and wherein said test equipment includes a plurality of frequency band filters which are switchably interconnected in series between at least one test head and at least one of said subscriber line and said splitter, thereby to provide switchable testing of at least one of said subscriber line and said splitter at a plurality of frequency bands.

9. A testing arrangement according to claim 2 and also including at least one switch interconnecting said test equipment with at least one of said splitter and said subscriber.

10. A testing arrangement according to claim 9 and wherein at least part of said at least one switch is integrated with said splitter in a single housing.

11. A testing arrangement according to claim 9 and wherein said at least one switch includes at least one first switch, switchably interconnecting said test equipment with a subscriber line extending from said splitter to said subscriber and at least one second switch switchably interconnecting said test equipment with said splitter.

12. A testing arrangement according to claim 11 and wherein
said at least one second switch comprises a pair of second switches; and
said splitter comprises first and second frequency band filters; and wherein
each of said pair of second switches switchably interconnects one of said first and second frequency band filters to said test equipment.

13. A testing arrangement according to claim 9 and wherein said at least one switch includes a high-impedance switch assembly for low interference switching between said test equipment and said subscriber line, thereby to minimize interference with live communications thereon.

14. A testing arrangement according to claim 9 and wherein said test equipment includes a plurality of frequency band filters which are switchably interconnected in series between at least one test head and at least one of said subscriber line and said splitter, thereby to provide switchable testing of at least one of said subscriber line and said splitter at a plurality of frequency bands.

15. A testing arrangement according to claim 4 and wherein said at least one switch includes at least one first switch, switchably interconnecting said test equipment with a subscriber line extending from said splitter to said subscriber and at least one second switch switchably interconnecting said test equipment with said splitter.

16. A testing arrangement according to claim 10 and wherein said at least one switch includes at least one first switch, switchably interconnecting said test equipment with a subscriber line extending from said splitter to said subscriber and at least one second switch switchably interconnecting said test equipment with said splitter.

17. A testing arrangement according to claim 15 and wherein
said at least one second switch comprises a pair of second switches; and
said splitter comprises first and second frequency band filters; and wherein
each of said pair of second switches switchably interconnects one of said first and second frequency band filters to said test equipment.

18. A testing arrangement according to claim 16 and wherein
said at least one second switch comprises a pair of second switches; and
said splitter comprises first and second frequency band filters; and wherein
each of said pair of second switches switchably interconnects one of said first and second frequency band filters to said test equipment.

19. A testing arrangement according to claim 4 and wherein said at least one switch includes a high-impedance switch assembly for low interference switching between said test equipment and said subscriber line, thereby to minimize interference with live communications thereon.

20. A testing arrangement according to claim 4 and wherein said test equipment includes a plurality of frequency band filters which are switchably interconnected in series between at least one test head and at least one of said subscriber line and said splitter, thereby to provide switchable testing of at least one of said subscriber line and said splitter at a plurality of frequency bands.

21. A testing arrangement according to claim 5 and wherein said at least one switch includes a high-impedance switch assembly for low interference switching between said test equipment and said subscriber line, thereby to minimize interference with live communications thereon.

22. A testing arrangement according to claim 5 and wherein said test equipment includes a plurality of frequency band filters which are switchably interconnected in series between at least one test head and at least one of said subscriber line and said splitter, thereby to provide switchable testing of at least one of said subscriber line and said splitter at a plurality of frequency bands.

23. A testing arrangement according to claim 6 and wherein said at least one switch includes a high-impedance switch assembly for low interference switching between said test equipment and said subscriber line, thereby to minimize interference with live communications thereon.

24. A testing arrangement according to claim 6 and wherein said test equipment includes a plurality of frequency band filters which are switchably interconnected in series between at least one test head and at least one of said subscriber line and said splitter, thereby to provide switchable testing of at least one of said subscriber line and said splitter at a plurality of frequency bands.

25. A testing arrangement according to claim 7 and wherein said test equipment includes a plurality of frequency band filters which are switchably interconnected in series between at least one test head and at least one of said subscriber line and said splitter, thereby to provide switchable testing of at least one of said subscriber line and said splitter at a plurality of frequency bands.

26. A testing arrangement according to claim 25 and wherein said at least one switch includes at least one first switch, switchably interconnecting said test equipment with a subscriber line extending from said splitter to said subscriber and at least one second switch switchably interconnecting said test equipment with said splitter.

27. A testing arrangement according to claim 25 and wherein
said at least one second switch comprises a pair of second switches; and
said splitter comprises first and second frequency band filters; and wherein
each of said pair of second switches switchably interconnects one of said first and second frequency band filters to said test equipment.

28. A testing arrangement according to claim 21 and wherein at least part of said at least one switch is integrated with said splitter in a single housing.

29. A testing arrangement according to claim 22 and wherein at least part of said at least one switch is integrated with said splitter in a single housing.

30. A testing arrangement according to claim 23 and wherein at least part of said at least one switch is integrated with said splitter in a single housing.

31. A testing arrangement according to claim 24 and wherein at least part of said at least one switch is integrated with said splitter in a single housing.

32. A testing arrangement according to claim 25 and wherein at least part of said at least one switch is integrated with said splitter in a single housing.

33. A testing method for use in a communications network carrying POTS and data traffic in an environment wherein a splitter is located between a data subassembly and a voice subassembly on one side and a subscriber on an opposite side, the testing method comprising switchably connecting test equipment between said splitter and said subscriber.

34. A testing method according to claim 33 and wherein said test equipment is located in relative propinquity to said splitter and to said data subassembly and said voice subassembly and relatively remotely from said subscriber.

35. A testing method according to claim 33 and also including interconnecting said test equipment with at least one of said splitter and said subscriber via at least one switch.

36. A testing method according to claim 34 and wherein at least part of said at least one switch is integrated with said splitter in a single housing.

37. A testing method according to claim 34 and wherein said at least one switch includes at least one first switch, switchably interconnecting said test equipment with a subscriber line extending from said splitter to said subscriber and at least one second switch switchably interconnecting said test equipment with said splitter.

38. A testing method according to claim 37 and wherein
said at least one second switch comprises a pair of second switches; and
said splitter comprises first and second frequency band filters; and wherein
each of said pair of second switches switchably interconnects one of said first and second frequency band filters to said test equipment.

39. A testing method according to claim 34 and wherein said at least one switch includes a high-impedance switch assembly providing low interference switching between said test equipment and said subscriber line, thereby to minimize interference with live communications thereon.

40. A testing method according to claim 34 and wherein said at least one switch includes a plurality of frequency band filters which are switchably interconnected in series between said test equipment and at least one of said subscriber line and said splitter, thereby to provide switchable testing of at least one of said subscriber line and said splitter at a plurality of frequency bands.

41. A testing method according to claim 33 and also including at least one switch interconnecting said test equipment with said splitter and said subscriber.

42. A testing method according to claim 41 and wherein at least part of said at least one switch is integrated with said splitter in a single housing.

43. A testing method according to claim 41 and wherein said at least one switch includes at least one first switch, switchably interconnecting said test equipment with a subscriber line extending from said splitter to said subscriber and at least one second switch switchably interconnecting said test equipment with said splitter.

44. A testing method according to claim 37 and wherein
said at least one second switch comprises a pair of second switches; and
said splitter comprises first and second frequency band filters; and wherein
each of said pair of second switches switchably interconnects one of said first and second frequency band filters to said test equipment.

45. A testing method according to claim 41 and wherein said at least one switch includes a high-impedance switch assembly for low interference switching between said test equipment and said subscriber line, thereby to minimize interference with live communications thereon.

46. A testing method according to claim 41 and wherein said at least one switch includes a plurality of frequency band filters which are switchably interconnected in series between said test equipment and at least one of said subscriber line and said splitter, thereby to provide switchable testing of at least one of said subscriber line and said splitter at a plurality of frequency bands.

47. A testing method according to claim 46 and wherein said at least one switch includes at least one first switch, switchably interconnecting said test equipment with a subscriber line extending from said splitter to said subscriber and at least one second switch switchably interconnecting said test equipment with said splitter.

48. A testing method according to claim 37 and wherein said at least one switch includes at least one first switch, switchably interconnecting said test equipment with a subscriber line extending from said splitter to said subscriber and at least one second switch switchably interconnecting said test equipment with said splitter.

49. A testing method according to claim 37 and wherein:
said at least one second switch comprises a pair of second switches; and
said splitter comprises first and second frequency band filters; and wherein
each of said pair of second switches switchably interconnects one of said first and second frequency band filters to said test equipment.

50. A testing method according to claim 38 and wherein
said at least one second switch comprises a pair of second switches; and
said splitter comprises first and second frequency band filters; and wherein
each of said pair of second switches switchably interconnects one of said first and second frequency band filters to said test equipment.

51. A testing method according to claim 36 and wherein said at least one switch includes a high-impedance switch assembly for low interference switching between said test equipment and said subscriber line, thereby to minimize interference with live communications thereon.

52. A testing method according to claim 36 and wherein said at least one switch includes a plurality of frequency band filters which are switchably interconnected in series between said test equipment and at least one of said subscriber line and said splitter, thereby to provide switchable testing of at least one of said subscriber line and said splitter at a plurality of frequency bands.

53. A testing method according to claim 37 and wherein said at least one switch includes a high-impedance switch assembly for low interference switching between said test equipment and said subscriber line, thereby to minimize interference with live communications thereon.

54. A testing method according to claim 37 and wherein said at least one switch includes a plurality of frequency band filters which are switchably interconnected in series between said test equipment and at least one of said subscriber line and said splitter, thereby to provide switchable testing of at least one of said subscriber line and said splitter at a plurality of frequency bands.

55. A testing method according to claim 38 and wherein said at least one switch includes a high-impedance switch assembly for low interference switching between said test equipment and said subscriber line, thereby to minimize interference with live communications thereon.

56. A testing method according to claim 38 and wherein said at least one switch includes a plurality of frequency band filters which are switchably interconnected in series between said test equipment and at least one of said subscriber line and said splitter, thereby to provide switchable testing of at least one of said subscriber line and said splitter at a plurality of frequency bands.

57. A testing method according to claim 39 and wherein said at least one switch includes a high-impedance switch assembly for low interference switching between said test equipment and said subscriber line, thereby to minimize interference with live communications thereon.

58. A testing method according to claim 39 and wherein said at least one switch includes a plurality of frequency band filters which are switchably interconnected in series between said test equipment and at least one of said subscriber line and said splitter, thereby to provide switchable testing of at least one of said subscriber line and said splitter at a plurality of frequency bands.

59. A testing method according to claim 40 and wherein said at least one switch includes a high-impedance switch assembly for low interference switching between said test equipment and said subscriber line, thereby to minimize interference with live communications thereon.

60. A testing method according to claim 40 and wherein said at least one switch includes a plurality of frequency band filters which are switchably interconnected in series between said test equipment and at least one of said subscriber line and said splitter, thereby to provide switchable testing of at least one of said subscriber line and said splitter at a plurality of frequency bands.

61. A testing method according to claim 41 and wherein said at least one switch includes a high-impedance switch assembly for low interference switching between said test equipment and said subscriber line, thereby to minimize interference with live communications thereon.

62. A testing method according to claim 41 and wherein said at least one switch includes a plurality of frequency band filters which are switchably interconnected in series between said test equipment and at least one of said subscriber line and said splitter, thereby to provide switchable testing of at least one of said subscriber line and said splitter at a plurality of frequency bands.

63. A testing method according to claim 57 and wherein said at least one switch includes at least one first switch, switchably interconnecting said test equipment with a subscriber line extending from said splitter to said subscriber and at least one second switch switchably interconnecting said test equipment with said splitter.

64. A testing method according to claim 57 and wherein:
said at least one second switch comprises a pair of second switches; and
said splitter comprises first and second frequency band filters; and wherein
each of said pair of second switches switchably interconnects one of said first and second frequency band filters to said test equipment.

65. A testing method according to claim 60 and wherein at least part of said at least one switch is integrated with said splitter in a single housing.

66. A testing method according to claim 61 and wherein at least part of said at least one switch is integrated with said splitter in a single housing.

67. A testing method according to claim 62 and wherein at least part of said at least one switch is integrated with said splitter in a single housing.

68. A testing method according to claim 63 and wherein at least part of said at least one switch is integrated with said splitter in a single housing.

69. A switching assembly useful in a testing arrangement for use in a communications network carrying POTS and data traffic in an environment wherein a splitter is located between a data subassembly and a voice subassembly on one side and a subscriber on an opposite side, the testing arrangement comprising test equipment switchably connected between said splitter and said subscriber, said switching assembly comprising at least one switch interconnecting said test equipment with said splitter and said subscriber.

70. A switching assembly according to claim 69 and wherein at least part of said at least one switch is integrated with said splitter in a single housing.

71. A switching assembly according to claim 69 and wherein said at least one switch includes at least one first switch, switchably interconnecting said test equipment with a subscriber line extending from said splitter to said subscriber and at least one second switch switchably interconnecting said test equipment with said splitter.

72. A switching assembly according to claim 71 and wherein:
said at least one second switch comprises a pair of second switches; and
said splitter comprises first and second frequency band filters; and wherein
each of said pair of second switches switchably interconnects one of said first and second frequency band filters to said test equipment.

73. A switching assembly according to claim 69 and wherein said at least one switch includes a high-impedance switch assembly for low interference switching between said test equipment and said subscriber line, thereby to minimize interference with live communications thereon.

74. A switching assembly according to claim 69 and wherein said test equipment is located in relative propinquity to said splitter and to said data subassembly and said voice subassembly and relatively remotely from said subscriber.

75. A switching assembly according to claim 70 and wherein said test equipment is located in relative propinquity to said splitter and to said data subassembly and said voice subassembly and relatively remotely from said subscriber.

76. A switching assembly according to claim 71 and wherein said test equipment is located in relative propinquity to said splitter and to said data subassembly and said voice subassembly and relatively remotely from said subscriber.

77. A switching assembly according to claim 72 and wherein said test equipment is located in relative propinquity to said splitter and to said data subassembly and said voice subassembly and relatively remotely from said subscriber.

78. A switching assembly according to claim 73 and wherein said test equipment is located in relative propinquity to said splitter and to said data subassembly and said voice subassembly and relatively remotely from said subscriber.

79. A switching matrix assembly useful with a switching assembly forming part of a testing arrangement for use in a communications network carrying POTS and data traffic in an environment wherein a splitter is located between a data subassembly and a voice subassembly on one side and a subscriber on an opposite side, the testing arrangement comprising test equipment switchably connected between said splitter and said subscriber, said switching assembly comprising at least one switch interconnecting said test equipment with said splitter and said subscriber, said switching matrix assembly comprising:
a plurality of frequency band filters which are switchably interconnected in series between said test equipment and at least one of said subscriber line and said splitter, thereby to provide switchable testing of at least one of said subscriber line and said splitter at a plurality of frequency bands.

80. A splitter useful in a communications network carrying POTS and data traffic in an environment wherein a splitter is located between a data subassembly and a voice subassembly on one side and a subscriber on an opposite side including a testing arrangement comprising test equipment switchably connected between said splitter and said subscriber, said splitter comprising at least one switch integrated with said splitter in a single housing.

81. A splitter according to claim 80 and wherein said at least one switch comprises first and second switches arranged in series with respective high and low pass filters.

82. A splitter according to claim 80 and wherein said at least one switch includes a high-impedance switch assembly for low interference switching between said test equipment and said subscriber line, thereby to minimize interference with live communications thereon.

83. A splitter according to claim 81 and wherein said at least one switch includes a high-impedance switch assembly for low interference switching between said test equipment and said subscriber line, thereby to minimize interference with live communications thereon.

84. A switching methodology useful in a testing arrangement for use in a communications network carrying POTS and data traffic in an environment wherein a splitter is located between a data subassembly and a voice subassembly on one side and a subscriber on an opposite side, the methodology comprising:
switchably connecting test equipment between said splitter and said subscriber, including employing at least one switch for interconnecting said test equipment with said splitter and said subscriber.

85. A switching methodology according to claim 84 and wherein at least part of said at least one switch is integrated with said splitter in a single housing.

86. A switching methodology according to claim 84 and wherein employing said at least one switch includes employing at least one first switch for switchably interconnecting said test equipment with a subscriber line extending from said splitter to said subscriber and at least one second switch for switchably interconnecting said test equipment with said splitter.

87. A switching methodology according to claim 86 and wherein:
said at least one second switch comprises a pair of second switches; and
said splitter comprises first and second frequency band filters; and wherein
each of said pair of second switches switchably interconnects one of said first and second frequency band filters to said test equipment.

88. A switching methodology according to claim 84 and wherein employing said at least one switch includes employing a high-impedance switch for low interference switching between said test equipment and said subscriber line, thereby to minimize interference with live communications thereon.

89. A switching methodology according to claim 84 and wherein said test equipment is located in relative propinquity to said splitter and to said data subassembly and said voice subassembly and relatively remotely from said subscriber.

90. A switching methodology according to claim 85 and wherein said test equipment is located in relative propinquity to said splitter and to said data subassembly and said voice subassembly and relatively remotely from said subscriber.

91. A switching methodology according to claim 86 and wherein said test equipment is located in relative propinquity to said splitter and to said data subassembly and said voice subassembly and relatively remotely from said subscriber.

92. A switching methodology according to claim 87 and wherein said test equipment is located in relative propinquity to said splitter and to said data subassembly and said voice subassembly and relatively remotely from said subscriber.

93. A switching methodology according to claim 88 and wherein said test equipment is located in relative propinquity to said splitter and to said data subassembly and said voice subassembly and relatively remotely from said subscriber.

94. A switching matrix methodology useful with a switching methodology employed in a testing arrangement for use in a communications network carrying POTS and data traffic in an environment wherein a splitter is located between a data subassembly and a voice subassembly on one side and a subscriber on an opposite side, the testing arrangement comprising test equipment switchably connected between said splitter and said subscriber, said switching methodology comprising employing at least one switch interconnecting said test equipment with said splitter and said subscriber, said switching matrix methodology comprising:
switchably interconnecting a plurality of frequency band filters in series between said test equipment and at least one of said subscriber line and said splitter, thereby to provide switchable testing of at least one of said subscriber line and said splitter at a plurality of frequency bands.
